(19) United States
(12) Patent Application Publication
(10) Pub. No.: US 2009/0197037 A1
(43) Pub. Date: Aug. 6, 2009

(54) METHOD FOR MANUFACTURING A CONDUCTIVE FABRIC AND PRODUCTS THEREOF

(76) Inventor: Hung-Jen CHEN, Kaohsiung City (TW)

Correspondence Address: Joe McKinney Muncy, PO Box 1364, Fairfax, VA, 22038-1364, US

(21) Appl. No.: 12/026,418

(22) Filed: Feb. 5, 2008

(51) Int. Cl. B32B 3/06; D04H 13/00

(52) U.S. Cl. 428/102; 156/148

(57) ABSTRACT

A method for manufacturing a conductive fabric and products thereof mainly fastens a first soft base and a second soft base with a conductive yarn interposed between them with spaced dot-type fastening spots through a fastening means to facilitate fast production of the conductive fabric. The fastening means could be a needle punching apparatus to provide needle punching on an upper layer fabric and a lower layer fabric without hitting the conductive yarn interposed between them. Thus all three of them can be fastened with the spaced dot-type fastening spots. And the conductive fabric can be produced more efficiently.

### FIELD OF THE INVENTION

The present invention relates to a method for manufacturing a conductive fabric and products thereof and particularly to a method employing a fastening means to form spaced dot-type fastening spots on a first soft base and a second soft base to bind a conductive yarn laid between them to facilitate fast production of the conductive fabric.

### BACKGROUND OF THE INVENTION

A conventional method to fabric a conductive fabric, referring to FIG. 1, generally is accomplished by direct knitting and weaving a conductive yarn 12 into a soft base 11. While such an approach can bind the conductive yarn 12 with the soft base 11, but the finished conductive fabric 10 is more expensive and production time is longer.

To remedy this problem, some producers try to sew conductive yarns 22 directly on a soft base 21 according to a preset layout to form a conductive fabric 20 (referring to FIG. 2). But the conductive yarn 22 could receive drastic friction during the sewing operation and be damaged or even rupture. The sewed conductive yarn 22 also easily loosens off and results in a lower quality of the conductive fabric 20.

### SUMMARY OF THE INVENTION

In view of the disadvantages of the manufacturing method and products of the conventional conductive fabrics, the primary object of the present invention is to provide an improved method to produce conductive fabrics faster.

The method of the invention mainly binds a conductive yarn between a first soft base and a second soft base through a fastening means by spaced dot-type fastening spots. The fastening means could be a needle punching apparatus to bind an upper layer textile and a lower layer textile in a needle punching fashion to form spaced dot-type fastening without hitting the conductive yarn laid between them. Thus the finished products of the conductive fabric can be produced faster.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a top view of a conductive fabric produced by conventional knitting and weaving.

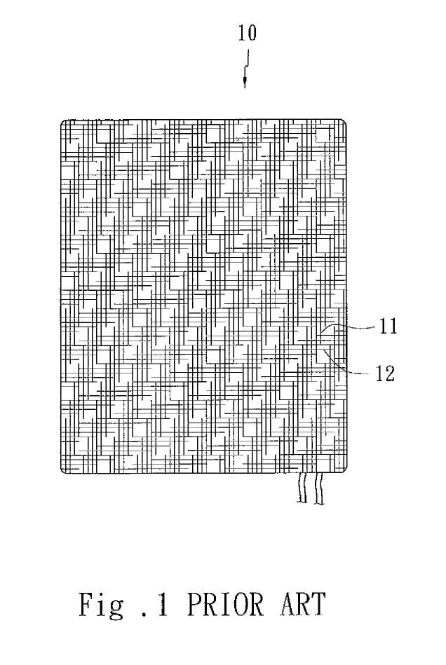

FIG. 2 is a top view of a conductive fabric produced by conventional sewing.

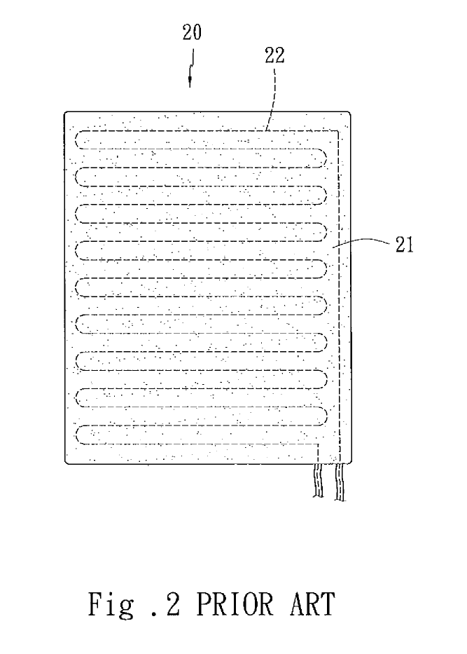

FIG. 3 is an exploded view of a conductive fabric according to the invention.

FIG. 4 is a front sectional view of the conductive fabric of the invention in a binding condition.

FIG. 5 is a top view of the fastening means of the invention laid in a regular fashion.

FIG. 6 is a top view of the fastening means of the invention laid in a staggered fashion.

FIG. 7 a top view of the fastening means of the invention laid in a spot fashion around a conductive yarn.

FIG. 8 is a schematic view of a conductive fabric of the invention formed by thermal bonding or pressing a first soft base and a second soft base that consist of an upper layer and a lower layer made from textiles or nonwovens, and rubber material, synthetic resins and polymers.

### DETAILED DESCRIPTION OF THE PREFERRED EMBODIMENTS

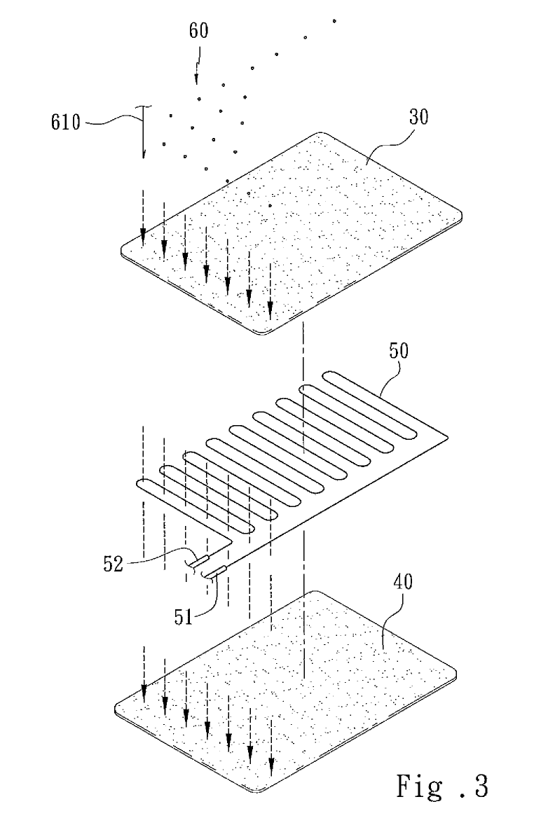

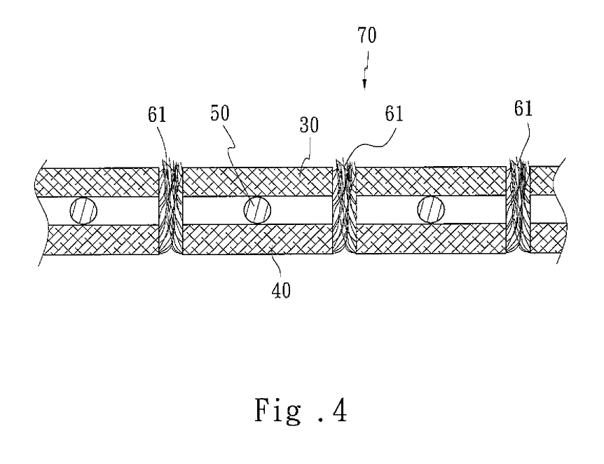

Please refer to FIGS. 3 and 4 for an embodiment of the manufacturing method of the invention to fabricate a conductive fabric 70. The method includes disposing a conductive yarn 50 between a first soft base 30 and a second soft base 40 on an upper layer and a lower layer in a symmetrical or asymmetrical manner. The first soft base 30 and the second soft base 40 are textiles or nonwovens. The conductive yarn 50 is a stainless steel fibre yarn, an alloy fibre yarn, a carbon fibre yarn, a silver fibre yarn, a copper fibre yarn, or other metal yarns or non-metal conductive yarns. The conductive yarn 50 also has a first electric coupling end 51 and a second electric coupling end 52 (or more than one set) extended outwards between the first and second soft bases 30 and 40. The conductive yarn 50 is fastened through a constructing portion 610 of a fastening means 60 in a fashion of spaced dot-type spots without being hit. The fastening means 60 is a needle punching apparatus in this embodiment. The constructing portion 610 is a punch needle. The spaced dot-type spots 61 are formed by entangling the fibres so that the conductive yarn 50 and the first and second soft bases 30 and 40 at the upper and lower layer are bound together to form the conductive fabric 70 without damaging the conductive yarn 50.

Moreover, the conductive yarn 50 is first bonded to the first soft base 30 or the second soft base 40 in a symmetrical or asymmetrical manner; next, the second soft base 40 or the first soft base 30 is covered thereon; then the two soft bases at the upper and lower sides are fastened together by means of the constructing portion 610 of the fastening means 60 through spaced dot-type spots without hitting the conductive yarn 50.

The construction portion 610 may be hydroentangling using high speed water ejection to form the spaced dot-type spots to bind the fibres.

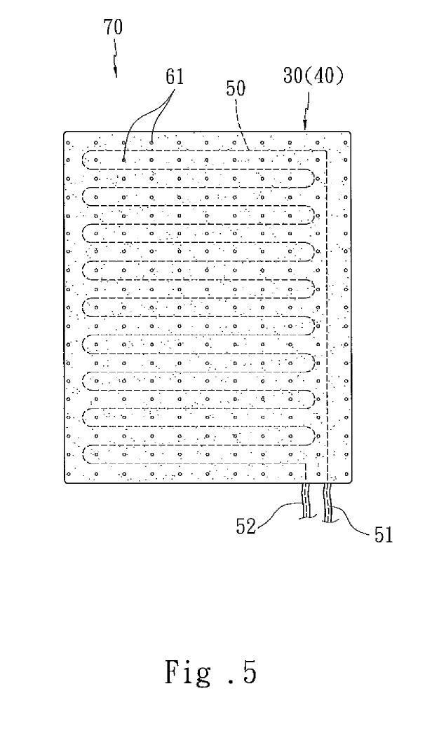

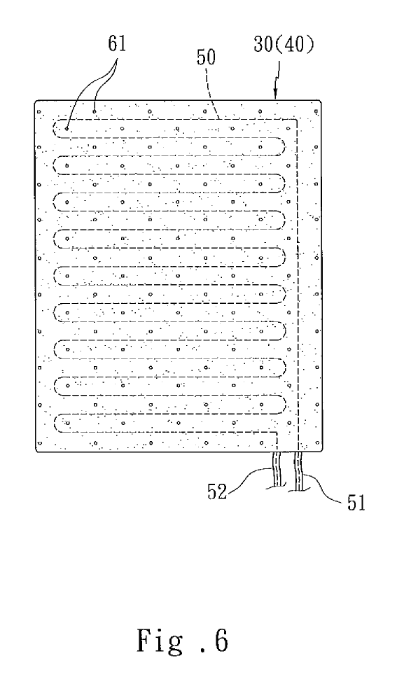

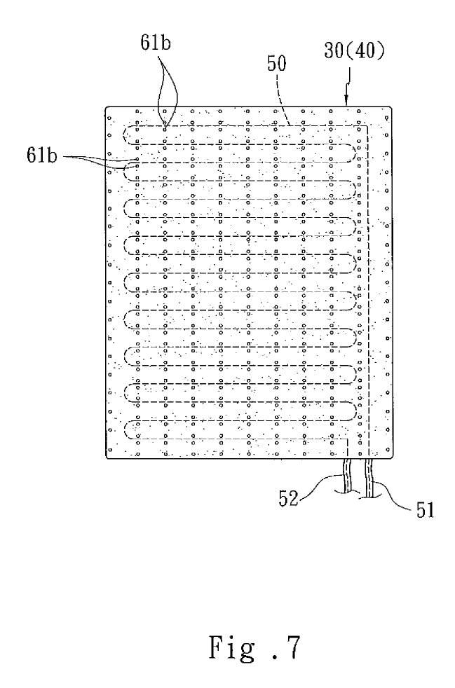

Referring to FIG. 5, the spaced dot-type spots 61 formed by the constructing portion 610 (referring to FIG. 3) on the conductive fabric 70 may be in a regular fashion, or a staggered fashion as shown in FIG. 6, or around the conductive yarn 50 as shown by fastening spots 61b in FIG. 7.

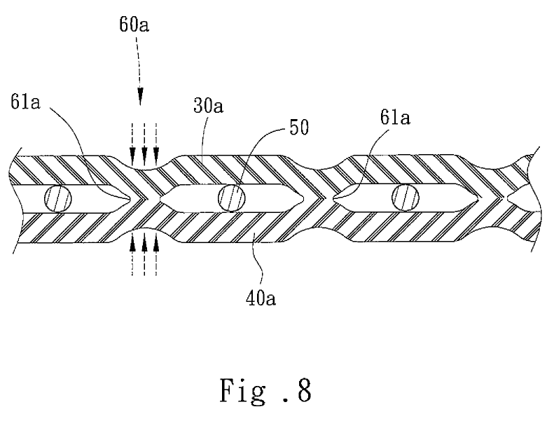

Referring to FIG. 8, the constructing portion 610 to form the spaced dot-type fastening spots 61a may also be a thermal bonding means or thermal pressing means. In such an embodiment the first and second soft bases 30a and 40a consist of textiles or nonwovens at the upper later and the lower layer, and rubber material, synthetic resins or polymers that are thermally bonded or thermally pressed to form a secured binding to quickly fasten the conductive yarn 50 between the first and second soft bases 30a and 40a of the upper and lower layers in a dot-type fastening spots manner to form the conductive fabric 70.

As a conclusion, the invention provides a method to manufacture a conductive fabric that has the first and second soft bases 30 and 40 at the upper and lower layers with the conductive yarn 50 laid between them to form a circuit in a symmetrical or asymmetrical fashion. Then the first and second soft bases 30 and 40 and the conductive yarn 50 are fastened through the constructing portion 610 of the fastening means 60 in a fashion of spaced dot-type fastening spots. Such an approach can fabricate the conductive fabric 70 quickly and form a more secure binding and overcome the problems occurred to the conventional techniques of knitting and weaving or direct sewing. It provides a significant improvement.

What is claimed is:

1. A method for manufacturing a conductive fabric, comprising:
disposing a conductive yarn between a first soft base and a second soft base located respectively on a upper layer and a lower layer to form a circuit layout in a symmetrical or asymmetrical fashion; and
forming spaced dot-type fastening spots between the first soft base and the second soft base through a constructing portion of a fastening means to fasten the conductive yarn rapidly between the first soft base and the second soft base.

2. The method of claim 1, wherein the first soft base and the second soft base are textiles or nonwovens, and the fastening means is a needle punching apparatus or a hydroentangling apparatus to form the spaced dot-type fastening spots through entangled fibres to bind the textiles or nonwovens.

3. The method of claim 1, wherein the constructing portion of the fastening means produces a regular or staggered layout.

4. The method of claim 1, wherein the spaced dot-type fastening spots are located around the conductive yarn.

5. The method of claim 1, wherein the first soft base and the second soft base consist of textiles or nonwovens, rubber material, synthetic resins and polymers, and the fastening means is a thermal bonding or thermal pressing apparatus to form the spaced dot-type fastening spots on the textiles or nonwovens, rubber material, synthetic resins and polymers for bonding and fastening.

6. The method of claim 1, wherein the conductive yarn has one or more electric coupling end extended outwards between the first soft base and the second soft base.

7. The method of claim 1, wherein the conductive yarn is selected from the group consisting of stainless steel yarns, alloy fibre yarns, carbon fibre yarns, silver fibre yarns, copper fibre yarns, and other selected metal yarns or non-metal conductive yarns.

8. A conductive fabric comprising a first soft base located on a upper layer, a second soft base located on a lower layer and a conductive yarn which is located between the first soft base and the second soft base in a symmetrical or asymmetrical fashion and fastened by spaced dot-type fastening spots formed between the first soft base and the second soft base without hitting the conductive yarn.

9. The conductive fabric of claim 8, wherein the first soft base and the second soft base are textiles or nonwovens, and the spaced dot-type fastening spots are entangled fibres for fastening.

10. The conductive fabric of claim 8, wherein the spaced dot-type fastening spots are formed in a regular or staggered layout.

11. The conductive fabric of claim 8, wherein the spaced dot-type fastening spots are located around the conductive yarn.

12. The conductive fabric of claim 8, wherein the first soft base and the second soft base consist of textiles or nonwovens, rubber material, synthetic resins and polymers that are bonded and fastened by the spaced dot-type fastening spots.

13. The conductive fabric of claim 8, wherein the conductive yarn has one or more electric coupling end extended outwards between the first soft base and the second soft base.

14. The conductive fabric of claim 8, wherein the conductive yarn is selected from the group consisting of stainless steel yarns, alloy fibre yarns, carbon fibre yarns, silver fibre yarns, copper fibre yarns, and other selected metal yarns or non-metal conductive yarns.
